(19) United States
(12) Patent Application Publication
(10) Pub. No.: US 2025/0190090 A1
(43) Pub. Date: Jun. 12, 2025

(54) IMAGING APPARATUS, CONTROL METHOD FOR THE SAME, AND STORAGE MEDIUM

(71) Applicant: CANON KABUSHIKI KAISHA, Tokyo (JP)

(72) Inventor: NAOHIKO TSUCHIDA, Tokyo (JP)

(21) Appl. No.: 18/972,555

(22) Filed: Dec. 6, 2024

(30) Foreign Application Priority Data
Dec. 11, 2023 (JP) 2023-208224

(51) Int. Cl. G06F 3/04817; G06Q 50/00; H04N 23/63

(52) U.S. Cl. CPC G06F 3/04817; G06Q 50/01; H04N 23/63

(57) ABSTRACT

An imaging apparatus includes one or more memories, and one or more processors in communication with the one or more memories. The one or more processors and the one or more memories are configured to control to display, on a display, a plurality of posting conditions and information as to whether each of the posting conditions is satisfied, together with a live view image, and transmit, in a case where the posting conditions are satisfied, a captured image to an external apparatus.

### BACKGROUND

### Field of the Disclosure

The present disclosure relates to an imaging apparatus, a control method for the imaging apparatus, and a storage medium.

### Description of the Related Art

In recent years, more and more use cases of posting short clip moving images of about several tens of seconds on social networking services (hereinafter, referred to SNSs) have been seen in the diversification of SNSs (refer to Japanese Patent Application Laid-open No. 2021-15336).

Such use cases could occur by automatically posting a moving image mistakenly that is not intended to be posted or cannot be quickly determined to be one likely to infringe on his or her or others' privacy. However, some users that are not used to SNSs wish to post safe contents on SNSs in real time, demanding ideas for saving time and effort to post securely and in real time.

Japanese Patent Application Laid-open No. 2021-15336 discloses a technique of supporting the selection of an image to be posted on an SNS from among images that were captured.

However, given the recent demand indicated by increasing use cases where users wish to post captured images on SNSs in a timely manner, the selection of an image to be posted on SNSs from among images that were captured is not sufficient to meet the demand. For users, who wish to securely convey, express what they are in a timely manner, it is very significant to take measures to make it possible to support users in capturing images for the users to automatically post images on SNSs without anxiety. Consequently, it is difficult to solve the issue using the technique.

It could be convenient for users who frequently post images on SNSs to use a simple function of uploading images on SNSs without time and effort immediately after images are captured. Should the images however include an image a user does not wish to post on SNSs or an object that will be troublesome to a certain viewer or another viewer will find disagreeable, the image or the object could cause trouble.

### SUMMARY

The present invention is directed to allowing users to post images on social networking services easily without anxiety.

According to an aspect of the present disclosure, an imaging apparatus includes one or more memories and one or more processors that are in communication with the one or more memories. The one or more processors and the one or more memories are configured to control to display, on a display, a plurality of posting conditions and information as to whether each of the posting conditions is satisfied, together with a live view image, and transmit, in a case where the posting conditions are satisfied, a captured image to an external apparatus.

Further features of various embodiments will become apparent from the following description of exemplary embodiments with reference to the attached drawings.

### BRIEF DESCRIPTION OF THE DRAWINGS

FIG. 1 is a block diagram illustrating a configuration example of an imaging apparatus.

FIG. 2 is a diagram illustrating an example of automatic social networking service (SNS) posting conditions.

FIG. 3 is a flowchart illustrating a procedure of data transmission processing.

FIG. 4 is a diagram illustrating a display example of the imaging apparatus.

FIG. 5 is a diagram illustrating a display example of the imaging apparatus.

### DESCRIPTION OF THE EMBODIMENTS

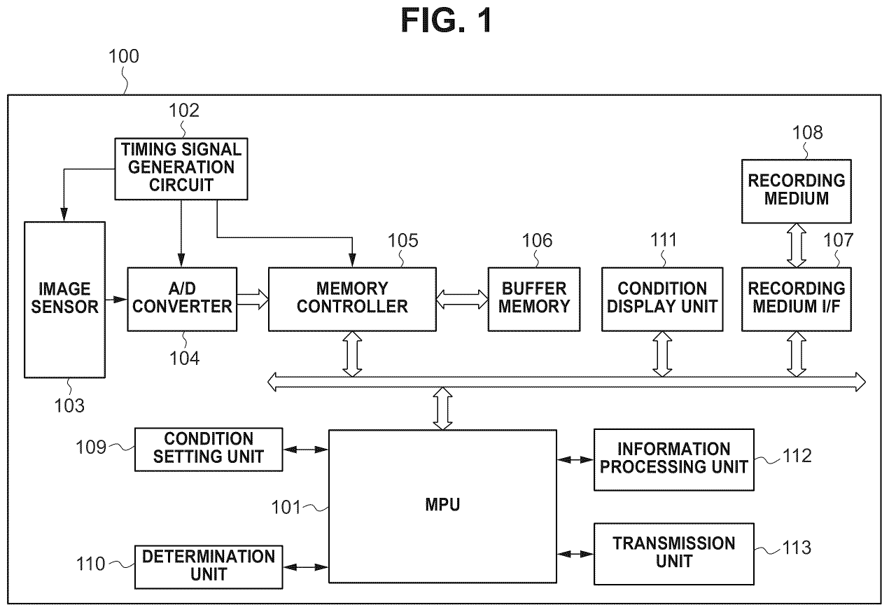

Exemplary embodiments will be described with reference to the attached drawings. FIG. 1 is a block diagram illustrating a configuration example of an imaging apparatus 100 according to an exemplary embodiment. However, the configuration that will be described is merely an example, and not limited thereto.

The imaging apparatus 100 is an electronic apparatus provided with a camera function, for example, a camera, such as a digital camera and a digital video camera, a mobile phone provided with a camera function, and a computer provided with a camera function.

In FIG. 1, the imaging apparatus 100 includes a micro processing unit (MPU) 101, a timing signal generation circuit 102, an image sensor 103, an analog-to-digital (A/D) converter 104, a memory controller 105, a buffer memory 106, a recording medium interface (I/F) 107, and a recording medium 108. Further, the imaging apparatus 100 includes a condition setting unit 109, a determination unit 110, a condition display unit 111, an information processing unit 112, and a transmission unit 113.

The MPU 101 is a microcontroller for performing system-related controls of the imaging apparatus 100, such as an imaging sequence control. The MPU 101 sets a condition or conditions as to whether to allow an automatic posting, determines whether the conditions are satisfied, and controls an automatic posting on a social networking service (SNS).

The timing signal generation circuit 102 generates timing signals for operating the image sensor 103, the A/D converter 104, and the memory controller 105.

The image sensor 103 is an image sensor, such as a charge-coupled device (CCD) sensor and a complementary metal-oxide semiconductor (CMOS) sensor, for converting light reflected from an object into electrical signals.

The A/D converter 104 converts analog image data read from the image sensor 103 into digital image data.

The memory controller 105 temporarily stores tag information to be displayed on the condition display unit 111, and controls a read/write operation on a memory, and a refresh operation on the buffer memory 106.

The buffer memory 106 stores the digital image data.

The recording medium I/F 107 is an interface for controlling reading and writing of data from and into the recording medium 108.

The recording medium 108 is, for example, a memory card or a hard disk drive to store programs.

The condition setting unit 109 performs a control to set conditions in advance for automatically posting captured moving or still images on SNSs. In this way, users can determine in advance whether to allow automatic posting on SNSs before image capturing. This eliminates the need for a user to determine whether to automatically post an image immediately after capturing the image, enabling users to avoid automatically posting images on SNSs with erroneous decisions.

It is important to prepare a plurality of conditions, making it possible to deal with various situations which users encounter and to use functions in line with the intentions of users. The conditions will be described in detail below.

The determination unit 110 has a function of determining whether the object(s) or the imaging conditions satisfy the above-described conditions determined by the user in advance.

The condition display unit 111 has a function of displaying condition information determined by the user in advance in an easily recognizable manner. The condition information can be character information or be displayed with easy-to-understand icons. As described above, to deal with various situations that users encounter, it is desirable to prepare a plurality of conditions described above.

However, it is extremely difficult for a user to always remember what conditions are set by himself or herself in image-capturing. It thus is important that the imaging apparatus 100 have a function of allowing the user to check the conditions easily during image-capturing, even if the user forgets the plurality of above-described conditions set by himself or herself in advance.

Further, it is also important that the condition display unit 111 have a function of changing the display between when the conditions are satisfied and when the conditions are not satisfied. In this way, the user can easily check whether the conditions for automatic SNS posting are satisfied in image-capturing.

As described above, it is important for the functions of the condition setting unit 109 and the condition display unit 111 to produce a synergy effect, realizing the imaging apparatus 100 that has a user-friendly automatic SNS posting function.

In addition, the imaging apparatus 100 according to the present exemplary embodiment automatically makes a post on an SNS as long as the conditions previously set are satisfied, preventing, to the utmost, even users with low internet or social media literacy from automatically making posts on SNSs mistakenly.

The information processing unit 112 has a function of processing the result of the determination as to whether the conditions are satisfied made by the determination unit 110, and controlling the display of the condition display unit 111.

In the present exemplary embodiment, it is important that the condition display unit 111 have the function of displaying the content that the conditions are satisfied. As an example to achieve the function, the imaging apparatus 100 according to the present exemplary embodiment includes the information processing unit 112. The imaging apparatus 100 provided with the information processing unit 112 makes the function useful particularly in a case where the display of the condition display unit 111 can be changed quickly and timely.

The transmission unit 113 has a function of automatically transmitting captured still or moving images to SNS servers with the above-described conditions previously determined satisfied.

The imaging apparatus 100 according to the present exemplary embodiment can include an operation unit, such as a simple posting button for making a post on an SNS. It is desirable that making a post on an SNS be enabled with the above-described conditions satisfied even when an operation unit for allowing a user to make a post on an SNS easily is available.

Further, the imaging apparatus 100 according to the present exemplary embodiment can have a function of previously setting an SNS for the user to automatically make posts on. This provides a function of automatically making posts on the SNS in a timelier manner without time and effort of users.

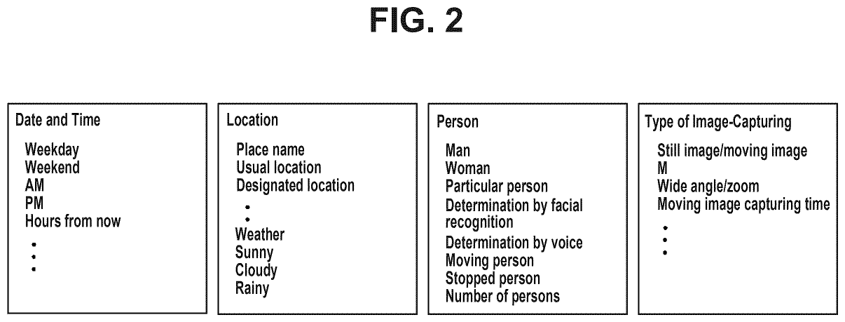

FIG. 2 is a diagram illustrating an example of conditions for automatic SNS posting according to the present exemplary embodiment. As conditions for automatic SNS posting, one condition or a plurality of conditions can be set. The condition(s) can be set appropriately through a previous selection of it or them by the user.

For example, the details of the condition(s) can be a date and time, a location, a weather, an object (e.g., a person), a still image or a moving image, imaging conditions (e.g., a type of imaging), and information related to privacy, and a combination of a plurality of conditions makes it possible to flexibly deal with the intention of the user and the situation that the user encounters.

As a date and time, the user can desirably set a desired imaging timing, such as a date, a weekday, a weekend, and a time zone.

As a location, a predetermined location can be designated using the name of the location in advance or based on global positioning system (GPS) information. For example, setting a location where making a post on any SNS is prohibited as a condition in advance to prohibit automatic posting on any SNS, avoiding automatically making a post on an SNS mistakenly.

Further, if the condition of a weather can be designated, the intention of the user can be easily reflected in image-capturing outside.

As an object, a particular person can be added to a condition or conditions, in addition to a man, a woman, and the number of persons. In this case, a method of, with a particular person previously registered with the imaging apparatus 100, determining the person using a facial recognition system in image-capturing is easy to understand. It is also important to include an object in conditions from the viewpoint of privacy. For example, with the number of persons registered limited to one, the user can avoid automatically making a post of an image showing another person registered for privacy on an SNS.

Further, a condition of the type of image-capturing, such as a still or moving image, can be designated. In particular, a moving image that can be posted is limited in time, such as the number of seconds, so that designating the upper limit makes it easy to use the imaging apparatus 100. As short clip moving images are favorably used to post on SNSs to convey what the user is doing these days, it is desirable that a short time (e.g., up to one minute, more desirably up to 20 seconds) can be set as a condition.

Further, it is desirable that imaging conditions, such as an image capturing mode, an F value, and a Tv value, can be incorporated, facilitating reflecting what the user wishes to convey in automatic SNS posting.

A condition to automatic posting or to prohibit automatic posting can be set or both of them can be desirably set to facilitate reflecting the intention of the user.

Further, the details of conditions of automatic SNS posting can be set through a selection by user or by the imaging apparatus 100 referring to external condition information already available to the public on the internet or presented by manufacturers of imaging apparatuses.

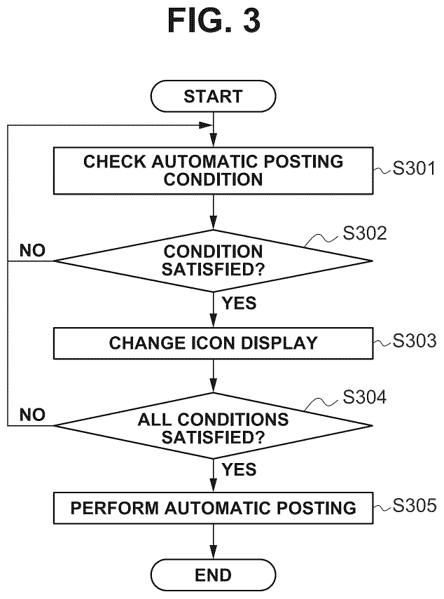

FIG. 3 is a flowchart illustrating an example procedure of a control method for the imaging apparatus 100 in FIG. 1.

The flowchart in FIG. 3 is implemented by the MPU 101 executing programs stored in the MPU 101 or another memory of the imaging apparatus 100. The flowchart in FIG. 3 is implemented in response to when the imaging apparatus 100 receives an imaging start operation, for example, the user's pressing an image capturing button on the imaging apparatus 100. The procedure of the flowchart in FIG. 3 is started by the user's pressing of the image capturing button.

In step S301, the condition setting unit 109 sets one or more automatic posting conditions. The MPU 101 checks the automatic posting condition(s) set by the condition setting unit 109. The automatic posting condition(s) can be checked constantly. Further, the MPU 101 can store the automatic posting condition(s) in the MPU 101 or the condition setting unit 109 at timing when the user sets the automatic posting condition(s).

The automatic posting condition(s) is or are related to still or moving images captured by the image sensor 103 in the imaging apparatus 100. The file of a captured still or moving image includes the image capturing information. As illustrated in FIG. 2, the automatic posting condition(s) is or are related to, for example, the date and time, the location, the weather, the object, the image capturing condition(s), or/and details related to the privacy when the still or moving image is captured.

For example, the automatic posting condition(s) is or include a condition of the imaging time period of the captured moving image. More specifically, the automatic posting condition(s) is or include a condition of moving images captured up to 20 seconds.

Further, the automatic posting condition(s) is or include a condition of the number of persons as objects in captured still or moving images. More specifically, the automatic posting condition(s) is or include a condition of one person in still or moving images as the total number of persons as objects.

In step S302, the determination unit 110 determines whether the still or moving image captured by the user with the image sensor 103 satisfies the above-described automatic posting condition(s). As the determination timing, the determination unit 110 can determine immediately after the image capturing, before the image capturing, or constantly during the image capturing. With a plurality of automatic posting conditions set, the determination unit 110 can desirably determine whether the automatic posting conditions are satisfied before or during the image capturing. In this way, the user can find out whether the automatic posting conditions are satisfied before or during the image capturing, leading to supporting the user's image capturing. Thus, with the imaging apparatus 100 equipped with a live view screen, the determination unit 110 can determine whether the automatic posting conditions are satisfied using the image displayed on the screen, facilitating the determination in real time, which is desirable because of an easy-to-understand measure for users.

If the automatic posting condition(s) is or are satisfied (YES in step S302), the processing proceeds to step S303. If not (NO in step S302), the processing returns to step S301.

In step S303, the MPU 101 changes character information or the icon display corresponding to each condition displayed on the condition display unit 111 to inform the user that the condition(s) is or are satisfied. For example, the MPU 101 can desirably make a display change recognizable by users at first glance, such as change of color or size. Thus, informing users as to which condition is not satisfied before or during image capturing enables further support of image capturing for automatic posting.

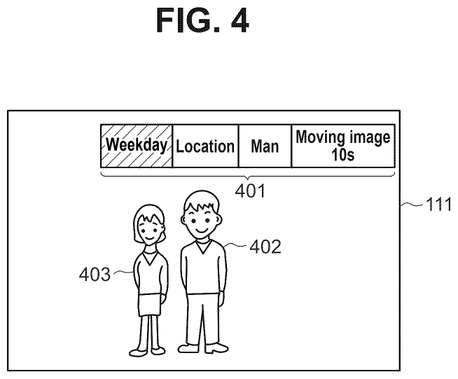

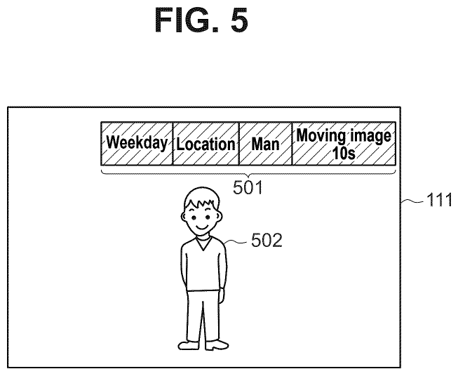

The MPU 101 functions as a display control unit to perform a control in such a manner that displays information as to whether the condition or each of the conditions of automatic posting is satisfied on the condition display unit 111 as with automatic posting condition information fields 401 and 501 illustrated in FIGS. 4 and 5. Examples of the information as to whether the condition or each of the conditions of automatic posting is satisfied includes icons and character information.

Whether the condition or each of the conditions of automatic posting is satisfied is indicated, for example, by different pieces of color information. Further, whether the condition or each of the conditions of automatic posting is satisfied can be indicated by different pieces of size information.

In step S304, the MPU 101 or the information processing unit 112 determines whether the automatic posting condition(s) set by the condition setting unit 109 is or are satisfied. This determination can be made by, for example, the MPU 101 or the information processing unit 112.

If the automatic posting condition(s) is or are satisfied (YES in step S304), the processing proceeds to step S305. If the automatic posting condition, not the automatic posting conditions, or no automatic posting conditions is or are satisfied (NO in step S304), the processing returns to step S301.

In step S305, the MPU 101 starts the processing of automatic posting on an SNS. The transmission unit 113 transmits to a desired SNS the still or moving image captured by the image sensor 103 on the imaging apparatus 100 described above, and the automatic posting is made. Then, the processing of the flowchart in FIG. 3 ends.

FIGS. 4 and 5 are diagrams each illustrating a configuration example of a display screen of the condition display unit 111 on the imaging apparatus 100 according to the present exemplary embodiment. The details of the automatic posting condition(s) are desirably displayed on the live view screen, allowing the user to check the state before or during image capturing. At this time, display is desirably performed in such a manner that does not hide the object(s) behind the information display of the condition details as illustrated in FIGS. 4 and 5.

In the present exemplary embodiment, an example will be described of a case of a moving image of ten seconds or less showing a man at a designated location on a weekday.

In the automatic posting condition information field 401 in FIG. 4, the image capturing timing satisfies the condition “weekday”. The location is not a designated location, and the condition of the “location” is not satisfied. Further, a woman 403 is captured other than a man 402 as objects, so that the condition of “person” is not satisfied. The moving image is captured more than 10 seconds, so that the condition of the “moving image” is not satisfied. In this case, the color of the icon (weekday icon) alone indicating the image capturing timing that satisfies the condition is changed. The set of the conditions allows ordinary image capturing, but prevents the automatic posting on SNSs after image capturing.

Next, in the automatic posting condition information field 501 in FIG. 5, the object and the location changed. The condition display illustrates one man 502 as an object in a moving image up to ten seconds to be captured at a designated location on a weekday, so that these conditions previously set are satisfied. Thus, the colors of the icons are changed, allowing the user to find out at first glance that the automatic posting on an SNS will be made after the image capturing. When an image is captured under these conditions, the processing in the flowchart illustrated in FIG. 3 is performed, carrying out the SNS automatic posting function.

As described above, the display of a condition or conditions to automatically make posts on SNSs on the condition display unit 111, the display of which allows users to find out whether the condition or each of the conditions is satisfied, produces an effect of supporting image capturing by users. Further, users can recognize whether automatic SNS posting will be made in real time, and users can easily use the automatic SNS posting function without anxiety.

As described above, according to the present exemplary embodiment, the imaging apparatus 100 allows users to make posts on SNSs without anxiety. Further, even users with low internet or social media literacy can easily use the SNS automatic posting function of the imaging apparatus 100 without anxiety.

In addition, not limited to the present exemplary embodiment, the configuration of the present disclosure can be also applied to cases where, for example, a user uses a mobile phone provided with a camera function application installed thereinto to activate the application and then captures an image to post the captured image on an SNS.

According to the present disclosure, users can post images on SNSs easily and without anxiety.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-208224, which was filed on Dec. 11, 2023 and which is hereby incorporated by reference herein in its entirety.

What is claimed is:

1. An imaging apparatus comprising:
one or more memories; and
one or more processors in communication with the one or more memories, wherein the one or more processors and the one or more memories are configured to:
control to display, on a display, a plurality of posting conditions and information as to whether each of the posting conditions is satisfied, together with a live view image; and
transmit, in a case where the posting conditions are satisfied, a captured image to an external apparatus.

2. The imaging apparatus according to claim 1, wherein the one or more processors and the one or more memories are further configured to allow a user to set the posting conditions.

3. The imaging apparatus according to claim 1, wherein the one or more processors and the one or more memories are further configured to, in a case where the posting conditions are satisfied, automatically transmit the captured image to the external apparatus.

4. The imaging apparatus according to claim 1, wherein the one or more processors and the one or more memories are further configured to control to display on the display, before or during capturing the image, the posting conditions and the information as to whether each of the posting conditions is satisfied, together with the live view image.

5. The imaging apparatus according to claim 1, wherein the one or more processors and the one or more memories are further configured to, in a case where not all the posting conditions or no posting conditions are satisfied, not transmit the captured image to the external apparatus.

6. The imaging apparatus according to claim 1, wherein the external apparatus is a social networking service (SNS) server.

7. The imaging apparatus according to claim 1, wherein the posting conditions are related to the captured image.

8. The imaging apparatus according to claim 1, wherein the posting conditions include an image capturing date and time, an image capturing location, a weather, an object, an image capturing condition, or content related to privacy, of the captured image.

9. The imaging apparatus according to claim 1, wherein the posting conditions include a condition of an image capturing time period of a captured moving image.

10. The imaging apparatus according to claim 9, wherein the posting conditions include a condition that the captured moving image is 20 seconds or less in length.

11. The imaging apparatus according to claim 1, wherein the posting conditions include a condition about the number of persons as objects in the captured image.

12. The imaging apparatus according to claim 11, wherein the posting conditions include a condition that the number of persons as the objects in the captured image is one.

13. The imaging apparatus according to claim 1, wherein the one or more processors and the one or more memories are further configured to control to display, on the display, the posting conditions each as an icon.

14. The imaging apparatus according to claim 13, wherein the one or more processors and the one or more memories are further configured to control to display the information as to whether each of the posting conditions is satisfied by changing a display form of the icon.

15. A control method for an imaging apparatus, comprising:
controlling to display, on a display, a plurality of posting conditions and information as to whether each of the posting conditions is satisfied, together with a live view image; and
transmitting, in a case where the posting conditions are satisfied, a captured image to an external apparatus.

16. A non-transitory computer-readable storage medium storing computer-executable instructions for causing a computer to perform a control method comprising:
controlling to display, on a display, a plurality of posting conditions and information as to whether each of the posting conditions is satisfied, together with a live view image; and
transmitting, in a case where the posting conditions are satisfied, a captured image to an external apparatus.
